(19) United States
(12) Patent Application Publication
(10) Pub. No.: US 2018/0174454 A1
(43) Pub. Date: Jun. 21, 2018

(54) METHOD AND SYSTEM FOR PREDICTING PARKING SPACE AVAILABILITY USING MULTI-FACTOR ANALYTICS

(71) Applicant: Mastercard International Incorporated, Purchase, NY (US)

(72) Inventors: Prashanna S. TIWAREE, New York, NY (US); Manash BHATTACHARJEE, Jersey City, NJ (US); Prashant SHARMA, Madison, NJ (US)

(73) Assignee: Mastercard International Incorporated, Purchase, NY (US)

(21) Appl. No.: 15/386,552

(22) Filed: Dec. 21, 2016

(51) Int. Cl. G08G 1/14; G07B 15/00; G06Q 40/00

(52) U.S. Cl. CPC G08G 1/148; G06F 17/30241; G06Q 40/12; G07B 15/00

(57) ABSTRACT

A method for predicting parking space availability using normalized data includes: storing a number of parking spaces for each of a plurality of geographic areas; storing a number of payment transactions for each geographic area processed during a related period of time; receiving an availability request a specific period of time; normalizing parking spot availability for each geographic area based on the associated number of parking spaces and an average number of parking spaces for the geographic areas; normalizing the number of payment transactions for each geographic area based on the number of transactions processed during the specific period of time and the number of transactions processed during a corresponding period of time; calculating a composite score for each geographic area based on the associated normalized parking spot availability and transaction frequency; and transmitting the calculated composite score for each geographic area in response to the received availability request.

### FIELD

The present disclosure relates to the predicting of parking space availability using multi-factor analysis, specifically using normalized data related to payment transactions conducted in a parking area and the number of parking spots available in the parking area for each parking area in an indicated region where a space availability prediction is requested.

### BACKGROUND

In dense urban areas, parking can be a hassle for individuals. Not only must an individual first locate a parking area, which may be difficult in a busy area, such as in Manhattan or the District of Columbia, the individual must then count on the parking area having an open parking space. In instances where the individual visits a parking area that is at capacity, they must begin their search over, finding another parking area and again hoping that the area has an available parking space.

In an effort to assist individuals in their search for a parking space, some methods have been developed to identify if a parking area has one or more spaces available. In one method, parking garages and other areas have sensors located at each parking space to identify if the space is occupied, where the status of the parking area (e.g., number of available spaces) is made available. However, this information is often not available remotely, instead requiring the individual to visit the parking area, and also requires significant modification to existing parking areas for implementation. Other methods rely on historical parking and transaction data to predict future parking capacity, such as described in U.S. patent application Ser. No. 14/858,297, entitled “Method and System for Assessing Parking Capacity,” filed on Sep. 18, 2015, which is herein incorporated by reference in its entirety. Such methods require historical parking metrics and other data for each parking area, which may be difficult, or in some cases even impossible, to identify.

Thus, there is a need for a technological solution to accomplish a more efficient method for predicting the availability of parking spaces that does not require modification to existing parking areas or systems, or require detailed parking metric data that may not be available for various parking areas.

### SUMMARY

The present disclosure provides a description of systems and methods for predicting parking space availability using normalized data. Using a number of parking spaces for an area and a number of payment transactions processed in the same area, when compared to historical data for transactions in the area, the methods discussed herein enable a composite score to be identified for each parking area that is indicative of the likelihood of availability of parking in that area. By normalizing the data, the composite score is reflective of the likelihood of a specific area when compared to other areas in a geographic region, providing an individual with an efficient and accurate assessment of parking availability, without requiring detailed parking metrics to be obtained, and without interaction with or modification to existing parking systems or areas.

A method for predicting parking space availability using normalized data includes: storing, in a parking database of a processing server, a plurality of parking data entries, wherein each parking data entry is a structured data set associated with a geographic area including at least a number of parking spaces in the associated geographic area; storing, in a transaction database of the processing server, a plurality of transaction data entries, wherein each transaction data entry is a structured data set associated with a period of time and a geographic area including at least a number of payment transactions originating in the associated geographic area and processed during the period of time; receiving, by a receiving device of the processing server, an availability request, wherein the availability request includes at least a geographic region comprised of a plurality of geographic areas and is received at a specific period of time; executing, by a querying module of the processing server, a query on the transaction database to identify, for each of the plurality of geographic areas, an associated transaction data entries where the associated geographic area corresponds to the respective geographic area and the associated period of time corresponds to the specific period of time; normalizing, by a calculation module of the processing server, parking spot availability for each of the plurality of geographic areas based on at least the number of parking spaces included in a parking data entry associated with the respective geographic area, and an average number of parking spaces included in the parking data entries associated with each of the plurality of geographic areas; normalizing, by the calculation module of the processing server, transaction frequency for each of the plurality of geographic areas based on at least the number of transactions included in a transaction data entry where the associated geographic area corresponds to the respective geographic area and the associated period of time corresponds to the specific period of time, and the number of transactions included in a transaction data entry where the associated geographic area corresponds to the respective geographic area and the associated period of time corresponds to an alternative period of time corresponding to the specific period of time; calculating, by the calculation module of the processing server, a composite score for each of the plurality of geographic areas based on at least the normalized parking spot availability and normalized transaction frequency for the respective geographic area; and electronically transmitting, by a transmitting device of the processing server, the calculated composite score for each of the plurality of geographic areas in response to the received availability request.

A system for predicting parking space availability using normalized data includes: a parking database of a processing server configured to store a plurality of parking data entries, wherein each parking data entry is a structured data set associated with a geographic area including at least a number of parking spaces in the associated geographic area; a transaction database of the processing server configured to store a plurality of transaction data entries, wherein each transaction data entry is a structured data set associated with a period of time and a geographic area including at least a number of payment transactions originating in the associated geographic area and processed during the period of time; a receiving device of the processing server configured to receive an availability request, wherein the availability request includes at least a geographic region comprised of a plurality of geographic areas and is received at a specific period of time; a querying module of the processing server configured to execute a query on the transaction database to identify, for each of the plurality of geographic areas, an associated transaction data entries where the associated geographic area corresponds to the respective geographic area and the associated period of time corresponds to the specific period of time; a calculation module of the processing server configured to normalized parking spot availability for each of the plurality of geographic areas based on at least the number of parking spaces included in a parking data entry associated with the respective geographic area, and an average number of parking spaces included in the parking data entries associated with each of the plurality of geographic areas, normalize transaction frequency for each of the plurality of geographic areas based on at least the number of transactions included in a transaction data entry where the associated geographic area corresponds to the respective geographic area and the associated period of time corresponds to the specific period of time, and the number of transactions included in a transaction data entry where the associated geographic area corresponds to the respective geographic area and the associated period of time corresponds to an alternative period of time corresponding to the specific period of time, and calculate a composite score for each of the plurality of geographic areas based on at least the normalized parking spot availability and normalized transaction frequency for the respective geographic area; and a transmitting device of the processing server configured to electronically transmit the calculated composite score for each of the plurality of geographic areas in response to the received availability request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for predicting parking space availability using normalized data in accordance with exemplary embodiments.

FIG. 2 is a block diagram illustrating the processing server of the system of FIG. 1 for predicting parking space availability using normalized data in accordance with exemplary embodiments.

FIG. 3 is a flow diagram illustrating a process for generating a heat map indicative of parking space availability using the system of FIG. 1 in accordance with exemplary embodiments.

FIG. 4 is a diagram illustrating the calculation of composite scores indicating parking space availability in accordance with exemplary embodiments.

FIG. 5 is a diagram illustrating a heat map generated to indicate parking space availability based on composite scores generated using normalized data in accordance with exemplary embodiments.

FIG. 6 is a flow chart illustrating an exemplary method for predicting parking space availability using normalized data in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

### System for Predicting Parking Space Availability

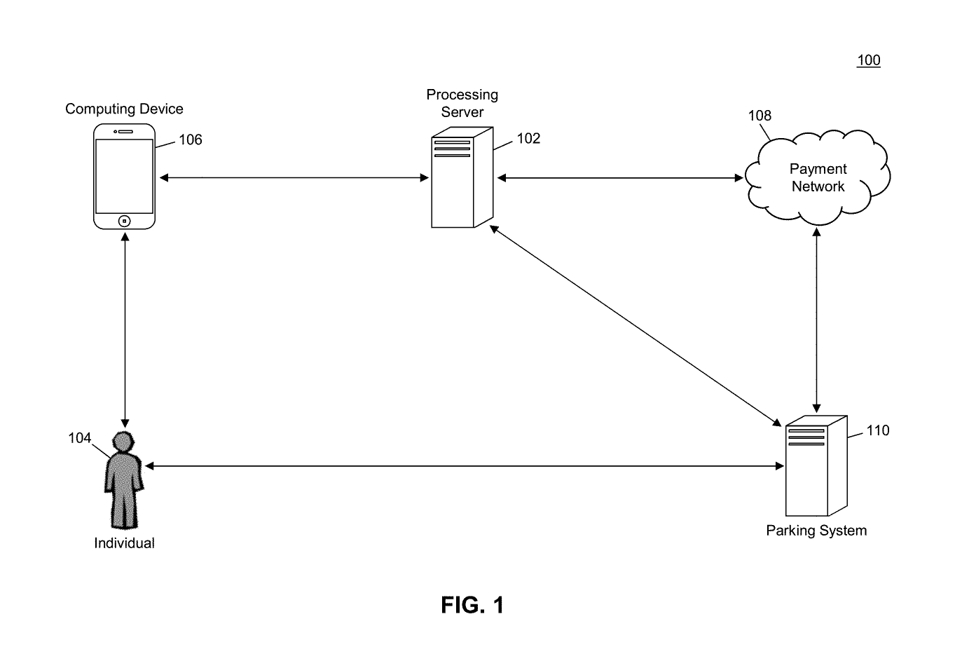

FIG. 1 illustrates a system 100 for the prediction of parking space availability using normalized data related to the number of available parking spots in a given area and the number of payment transactions processed in that area.

The system 100 may include a processing server 102. The processing server 102, discussed in more detail below, may be configured to predict the availability of parking spaces in a plurality of geographic areas in a geographic region based on normalized data associated therewith. In the system 100, an individual 104 may be traveling to a geographic region where they may be interested in parking. The individual 104 may request a prediction of parking space availability from the processing server 102 for the geographic region.

In an exemplary embodiment, the individual 104 may submit the request to the processing server 102 using a computing device 106. The computing device 106 may be any type of computing device suitable for performing the functions discussed herein, such as a desktop computer, laptop computer, notebook computer, tablet computer, cellular phone, smart phone, smart watch, smart television, wearable computing device, implantable computing device, etc. The computing device 106 may be configured to electronically transmit data to the processing server 102 using a suitable communication network, such as a cellular communication network or the Internet, where the data includes a geographic region for which the prediction is requested.

In some embodiments, the computing device 106 may submit the request via a web page associated with the processing server 102. In other embodiments, the computing device 106 may execute an application program stored therein that is associated with the processing server 102 and configured to exchange communications with the processing server 102 related to parking space availability. In yet other embodiments, the computing device 106 may submit the request via a messaging system, such as e-mail, short messaging service, multimedia messaging service, etc., and receive a response back from the processing server 102 using the same or an alternative system.

The computing device 106 may electronically transmit the geographic region for which a parking availability prediction is requested to the processing server 102. In some cases, the geographic region may be identified by the individual 104, such as from a selection of regions (e.g., displayed in a list, on a map, etc.). In other cases, the computing device 106 may identify its geographic location using a suitable detection method, where the geographic region may be identified based on the device's geographic location. In some instances, the geographic region may be a preset region comprised of a plurality of related geographic areas (e.g., as parking areas). In other instances, the geographic areas comprising the geographic region may be dependent on the selection and/or identification by the individual 104 or computing device 106. For instance, the individual 104 may manually select the parking areas that comprise the geographic region for which the prediction is requested.

In an example, a geographic region may be comprised of a plurality of different city blocks as geographic areas, where street parking, lot parking, parking garages, and other parking areas in each city block may comprise the parking area for the respective geographic location. In another example, a geographic region may be a set of city blocks, where the geographic areas may be parking lots or parking garages in the city blocks, with each parking area being a separate geographic area. In such cases, the level of granularity may be based on the size of the region, the number of parking areas in the region, settings provided by the computing device 106, or other suitable criteria.

The processing server 102 may receive the parking space availability request that includes the geographic region and may proceed to identify a composite score for a plurality of parking areas in the region, where the composite score is indicative of the likelihood of an availability parking space in the respective parking area as compared to the other parking areas located in the geographic region. The composite score for each geographic area (e.g., as a parking area) may be identified based on at least the number of parking spaces that are located at the geographic area as well as the number of payment transactions conducted at the geographic area versus historical transaction activity.

The processing server 102 may identify the number of parking spots at each of the geographic areas comprising the geographic region. In some embodiments, the processing server 102 may contact a parking system 110 that is associated with a parking area to request the number of parking spots in that parking area. The processing server 102 may also use other suitable methods to identify the number of parking spots, such as crowdsourcing, surveys, site inspections, etc. In some cases, the processing server 102 may use a combination of data sources, such as crowdsourced data from individuals 104 and confirmations via site inspections.

As part of the identification of the composite score for the geographic areas in the geographic region, the processing server 102 may normalize the number of parking spots in the geographic areas. The normalizing of the number of parking spots may be based on the number of parking spots for a given geographic area compared to the average number of parking spots for each of the geographic areas comprising the geographic region. In some instances, the normalized number may be calculated by dividing the number of parking spots in a geographic area by the average number of parking spots in all of the areas in the region.

The processing server 102 may also identify the transaction activity occurring in the geographic areas in the geographic region. The processing server 102 may receive payment transaction data from a payment network 108 or other entity associated with the processing of payment transactions, such as issuing or acquiring financial institutions, merchants, etc. In some embodiments, the processing server 102 may be a part of the payment network 108 and may receive the transaction data during the processing of the payment transactions. The transaction data may be comprised of at least a number of payment transactions conducted during a predetermined period of time. In some instances, the payment network 108 or other entity may provide the number of transactions and predetermined period of time. In other instances, the processing server 102 may receive transaction data for each payment transaction processed, and may be configured to identify the number of payment transactions for each period of time based thereon. In some cases, the processing server 102 may consider only those payment transactions related to the payment of parking, such as may be identified based on merchant identifiers, merchant category codes, or other data included in the transaction data for a payment transaction.

In some embodiments, the periods of time may be specific time windows for each day of the week. For instance, the payment transaction data may be separated into four hour blocks of time (e.g., 12 am to 4 am, 4 am to 8 am, 8 am to 12 pm, 12 pm to 4 pm, 4 pm to 8 pm, 8 pm to 12 am) for each day of the week. In such embodiments, the processing server 102 may identify transaction data for a period of time that corresponds to the time at which the composite score is requested. For example, if the individual 104 is requesting parking space availability on a Monday at 7 am, the processing server 102 may identify the transaction data for earlier Mondays in the 4 am to 8 am range.

In an exemplary embodiment, the processing server 102 may be configured to identify the number of transactions processed during the current period of time at or near real-time. In such embodiments, the processing server 102 may obtain the number of transactions being processed from the payment network 108 at a frequency sufficient to provide accurate parking space availability to the individual 104. For instance, in one example, the processing server 102 may request the number of transactions processed in the current period of time from the payment network 108 when a request is received from an individual 104. In another example, the payment network 108 may report payment transactions (e.g., at least the geographic location or associated geographic area) to the processing server 102 as they are processed. In some such instances, the processing server 102 may be a part of the payment network 102 and may identify the number of payment transactions being processed in the current period as part of the processing functions performed by the payment network 108.

The processing server 102 may be configured to normalize the number of payment transactions processed for each of the geographic areas in the geographic region. The normalized value for payment transactions for each geographic area may be based on at least the number of payment transactions in the geographic area processed in the present period of time and the number of payment transactions processed in the geographic area in one or more earlier, corresponding periods of time. For instance, the normalized value may be identified by dividing the number of present payment transactions by the historical average of payment transactions processed in the same period of time and day of the week in earlier weeks.

In some embodiments, the processing server 102 may be configured to identify the composite score for each geographic area in the geographic region based on at least the normalized number of parking spaces and the normalized number of payment transactions. For instance, the processing server 102 may calculate the composite score by dividing the normalized number of parking spaces by the normalized number of payment transactions for each geographic area, where the resulting value may be indicating of the likelihood of an available parking space in the respective geographic area. In such an instance, a higher composite score may indicate a higher likelihood of there being an available parking space, as the higher number of parking spaces indicates that there are more spaces in that area compared to the others in the region, and the lower number of payment transactions, which normalized and in the denominator would increase the composite score, indicate that not as many people are likely in the geographic area as usual at that time and day.

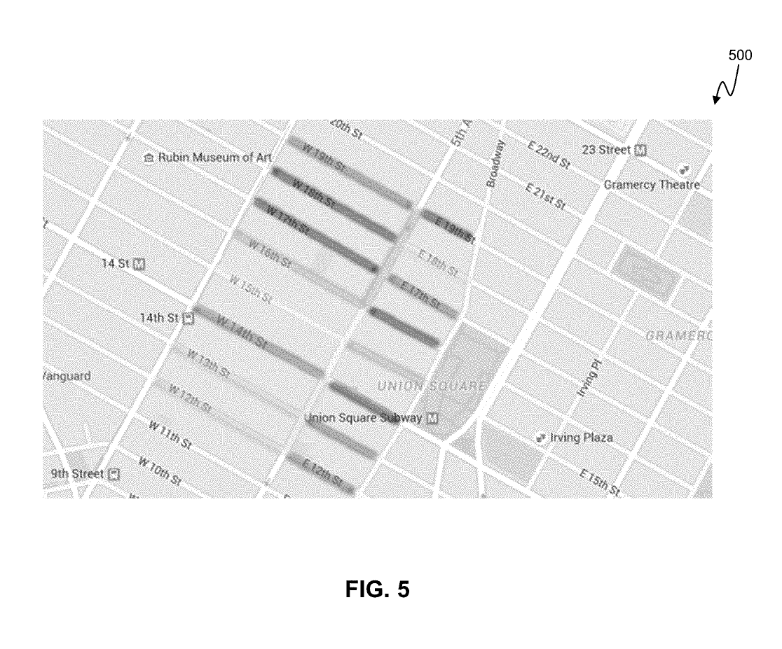

The processing server 102 may electronically transmit the calculated composite scores to the computing device 106, which may be presented to the individual 104 in any suitable format. For instance, in one example, the computing device 106 may display a list of the composite scores and their corresponding geographic areas to the individual. In another example, the composite scores may be converted to a different metric for presentation to the individual 104 in a list, such as by replacing the scores with a descriptor (e.g., “Highly Unlikely,” “Unlikely,” “Likely,” “Very Likely,” etc.). In yet another example, the processing server 102 or computing device 106 may generate a heat map, which may illustrate the geographic areas and indicate their likelihood of parking space availability based on the associated composite scores. An example of such a heat map is illustrated in FIG. 5 and discussed in more detail below. In some instances, the processing server 102 and/or computing device 106 may identify one or more geographic areas, based on the composite score, to recommend to the individual 104. In such instances, the computing device 106 may present the individual 104 with navigation instructions to the recommended geographic area.

In some embodiments, the processing server 102 may also utilize the cost of parking in each geographic area as part of the composite score. In such embodiments, the composite score may not only reflect the likelihood that a parking space is available in a geographic area, but also take into account the value of parking in that area. In these embodiments, the processing server 102 may be configured to obtain the parking cost for each of the geographic areas in the geographic region, such as from associated parking systems 110, crowdsourcing, site inspections, analysis of payment transactions involving parking in the geographic area, etc. The parking cost may be the cost of parking in the geographic area for a standardized period of time (e.g., cost for one hour of parking), or may be represented as the amount of time the individual 104 may park for a standardized amount of money (e.g., time earned for 25 cents).

The processing server 102 may be configured to normalize the parking cost for each of the geographic areas in the geographic region. The normalized parking cost for each geographic area may be based on at least the parking cost for the respective geographic area and an average parking cost for each of the geographic areas in the geographic region. In one embodiment, the processing server 102 may divide the parking cost for the geographic area by the average parking cost across all of the geographic areas in the geographic region.

The processing server 102 may use the normalized parking cost in the calculation of the composite score for the geographic areas. In such embodiments, the processing server 102 may divide the normalized parking cost by the normalized number of payment transactions for each geographic area, and then multiply the result by the normalized number of parking spaces to obtain the composite score. In some cases, the processing server 102 may first multiply the normalized parking cost by the normalized number of parking spaces, prior to dividing by the normalized number of payment transactions. The resulting composite score may thus indicate a combination of the likelihood that a parking space is available as well as the value of such a parking spot. In some cases, the calculation may be weighted, to increase or decrease each variable's effect on the composite score. For instance, the normalized parking cost may be weighted to have a smaller effect on the composite score, such as being multiplied by a smoothing factor.

In some cases, the individual 104 requesting the composite scores may provide instructions for weighting, such as by indicating (e.g., via the computing device 106) the importance of the value of the parking space as compared to the likelihood that a parking spot is available, which may specifically indicate importance for the number of payment transactions or the number of available spots. In such cases, the individual 104 may provide weights themselves, or the weights may be identified by the processing server 102 based on the individual-supplied criteria. For example, the computing device 106 may display a series of sliders for the individual 104 to indicate how important they find each variable that is used in calculating the composite score, where the processing server 102 may weigh the variables accordingly when calculating the composite score. In some such embodiments, the processing server 102 may return both weighted and unweighted composite scores, for presentation to the individual 104 via the computing device 106.

The methods and systems discussed herein enable the processing server 102 to accurately estimate the likelihood of the availability of a parking space in a geographic area based on other geographic areas in a geographic region, that takes into account the number of payment transactions associated with each area at or near real-time, and that uses normalization to provide composite scores that provide a suitable metric for identifying the likelihood of the availability of parking in a particular area as compared to other, nearby parking areas. As a result, an individual 104 may receive an accurate assessment of the likelihood of availability in each of a plurality of desired parking areas, which, in some embodiments, may also take into account the value of each parking area. Thus, individuals 104 may be provided with accurate and effective information, which may be provided without requiring modification to existing parking systems 110 or physical adjustments to parking areas.

### Processing Server

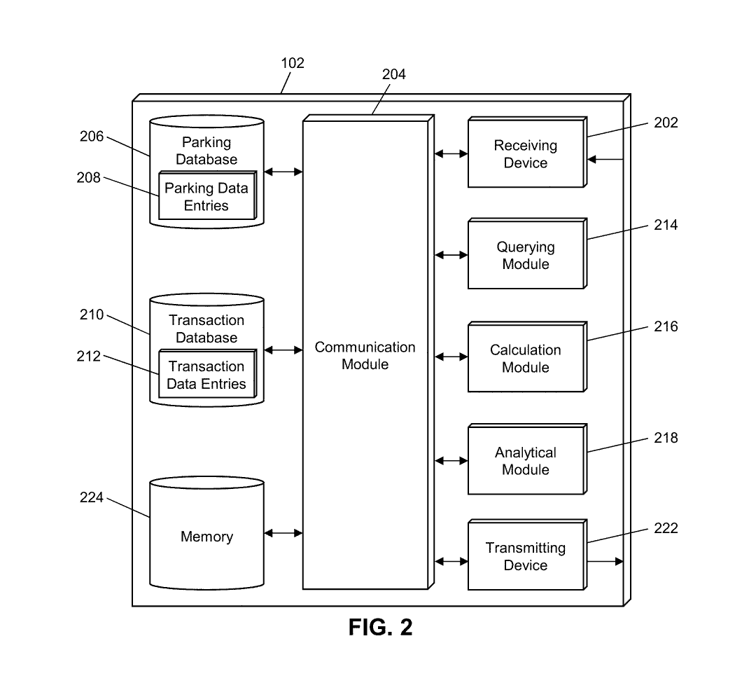

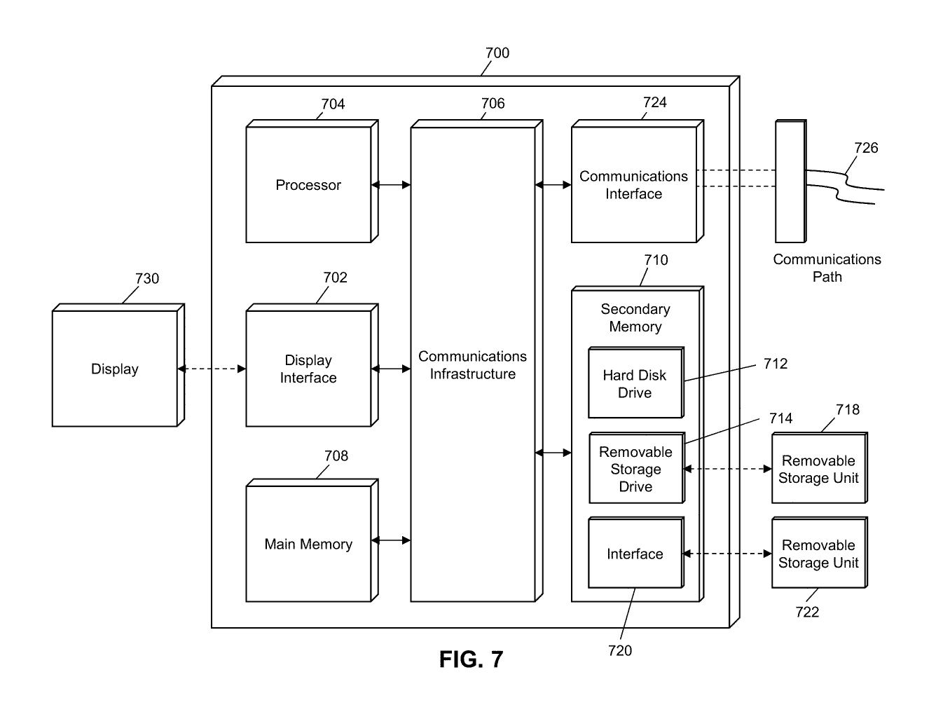

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 108 for the transmission of transaction messages that include sensitive financial data and information. In some instances, the receiving device 202 may also be configured to receive data from computing devices 106, payment networks 108, parking systems 110, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by computing devices 106, which may be superimposed or otherwise encoded with parking availability requests. Parking availability requests may indicate geographic regions and/or one or more geographic areas for which composite scores for parking availability are requested. In some cases, parking availability requests may also include a specified period of time for which availability is requested, indications of weights of variables used in calculating the composite score, presentation requests (e.g., heat maps, recommendations, etc.), or other suitable data. The receiving device 202 may also be configured to receive data signals electronically transmitted by payment networks 108, which may be superimposed or otherwise encoded with transaction data for payment transactions, where the transaction data may at least indicate the geographic area in which a payment transaction is located. The processing server 102 may also be configured to receive data electronically transmitted by parking systems 110 or other third party entities, which may include data related to the number of parking spots and the parking cost for geographic areas.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, calculation module 216, analytical module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include a parking database 206. The parking database 206 may be configured to store a plurality of parking data entries 208 using a suitable data storage format and schema. The parking database 206 may be a relational database that utilizes structured query language for the storage, identification, modifying, updating, accessing, etc. of structured data sets stored therein. Each parking data entry 208 may be a structured data set configured to store data related to a geographic area that offers parking. Each parking data entry 208 may include at least the number of parking spaces located in the related geographic area. In some instances, each parking data entry 208 may further include a parking cost associated with the related geographic area and other data that may be suitable for use in performing the functions discussed herein, such as data used in identifying the geographic area, associated geographic regions, merchants located in the geographic area, related parking systems 110, etc.

The processing server 102 may include a transaction database 210. The transaction database 210 may be configured to store a plurality of transaction data entries 212 using a suitable data storage format and schema. The transaction database 210 may be a relational database that utilizes structured query language for the storage, identification, modifying, updating, accessing, etc. of structured data sets stored therein. Each transaction data entry 212 may be a structured data set configured to store data related to a geographic area and a period of time. The transaction data entry 212 may include at least a number of payment transactions originating in the related geographic area that are processed during the related period of time. In some cases, the period of time may be a time range for a specific day of the week, day of the month, day of the year, or other date. For example, the period of time may be a four hour window of a specific day of the week (e.g., between 4 am and 8 am on a Monday). In some instances, the transaction database 210 may include a single transaction data entry 212 having a number of payment transactions in the geographic area processed during each of a plurality of corresponding periods of time (e.g., for each of a plurality of Mondays between 4 am and 8 am). In other instances, the transaction database 210 may have a separate transaction data entry 212 for each unique period of time (e.g., each Monday having a different transaction data entry 212 for the 4 am to 8 am range).

The processing server 102 may include a querying module 214. The querying module 214 may be configured to execute queries on databases to identify information. The querying module 214 may receive one or more data values or query strings, and may execute a query string based thereon on an indicated database, such as the parking database 206, to identify information stored therein. The querying module 214 may then output the identified information to an appropriate engine or module of the processing server 102 as necessary. The querying module 214 may, for example, execute a query on the parking database 206 to identify parking data entries 208 included therein that are related to geographic areas in a geographic region for which parking space availability is requested (e.g., as received by the receiving device 202).

The processing server 102 may also include a calculation module 216. The calculation module 216 may be configured to perform calculations of the processing server 102 for performing the functions discussed herein. The calculation module 216 may receive instructions as input, which may be accompanied with data, may perform calculations based on the instructions, and may output a result of the calculations to another module or engine of the processing server 102. For example, the calculation module 216 may be configured to calculate normalized numbers of parking spots for geographic areas based on the number of parking spots in the geographic area and the average number of parking spots in a plurality of other geographic areas comprising a geographic region, such as may be identified from their associated parking data entries 208. The calculation module 216 may also be configured to calculate normalized numbers of payment transactions and normalized parking costs for geographic areas, and to calculate composite scores that indicate likelihood of parking space availability for geographic areas based on the associated normalized data, as discussed herein.

The processing server 102 may also include an analytical module 218. The analytical module 218 may be configured to perform analysis for the processing server 102 to perform the functions discussed herein. The analytical module 218 may receive an instruction for analysis that is to be performed as input, may perform the analysis, and may output a result of the analysis to another module or engine of the processing server 102. In some instances, the input may include data that is to be analyzed or used in the analysis. In other instances, the analytical module 218 may be configured to identify the data to be used, such as by instructing the querying module 214 to execute a query on a relevant memory or database to identify the data. For example, the analytical module 218 may be configured to analyze composite scores for geographic areas to identify one or more preferred parking areas for recommendation to an individual 104. In some instances, the analytical module 218 may also be configured to analyze composite scores for the generation of a heat map to represent the likelihood of available parking spaces in a plurality of geographic areas comprising a geographic region.

The processing server 102 may also include a transmitting device 222. The transmitting device 222 may be configured to transmit data over one or more networks via one or more network protocols. In some embodiments, the transmitting device 222 may be configured to transmit data over the payment rails, such as using specially configured infrastructure associated with payment networks 108 for the transmission of transaction messages that include sensitive financial data and information, such as identified payment credentials. In some instances, the transmitting device 222 may be configured to transmit data to computing devices 106, payment networks 108, parking systems 110, and other entities via alternative networks, such as the Internet. In some embodiments, the transmitting device 222 may be comprised of multiple devices, such as different transmitting devices for transmitting data over different networks, such as a first transmitting device for transmitting data over the payment rails and a second transmitting device for transmitting data over the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to computing devices 106, which may be superimposed or otherwise encoded with composite scores for geographic areas or data associated therewith, such as parking recommendations, heat maps, navigation instructions, etc. The transmitting device 222 may also be configured to electronically transmit data signals to payment networks 108, which may be superimposed or otherwise encoded with requests for transaction data, such as may specify one or more geographic areas and/or periods of time for which transaction data is requested for use in performing the functions discussed herein. The transmitting device 222 may also be configured to electronically transmit data signals to parking systems 110, which may be superimposed or otherwise encoded with data requests, such as to request numbers of parking spots, parking costs, or other data for use in performing the functions of the processing server 102 discussed herein.

The processing server 102 may also include a memory 224. The memory 224 may be configured to store data for use by the processing server 102 in performing the functions discussed herein, such as public and private keys, symmetric keys, etc. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 224 may be comprised of or may otherwise include a relational database that utilizes structured query language for the storage, identification, modifying, updating, accessing, etc. of structured data sets stored therein.

### Process for Generating a Heat Map for Predicting Parking Space Availability

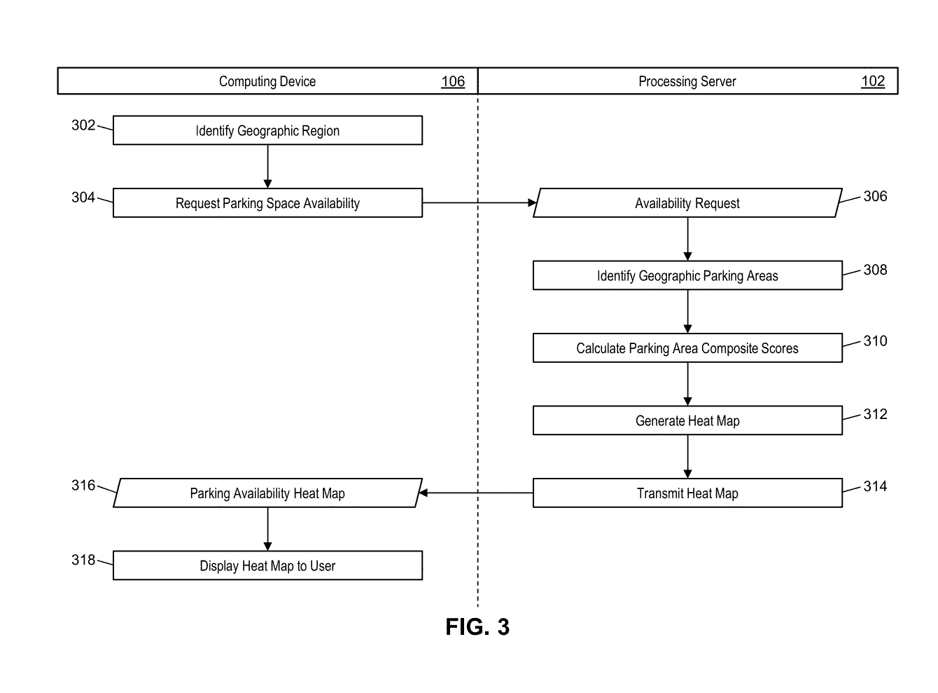

FIG. 3 illustrates a process for the generation of a heat map that illustrates the likelihood of availability of parking spaces in a plurality of geographic areas comprising a geographic region, as identified by the processing server 102 using normalized data.

In step 302, the computing device 106 may identify a geographic region for which parking availability is requested. In some instances, the computing device 106 may identify a geographic region in which it is located using suitable methods or systems, such as the global positioning system. In other instances, the individual 104, as a user of the computing device 106, may select a geographic region using a suitable input device of the computing device 106. The geographic region may be comprised of a plurality of geographic areas. In some cases, the individual 104 may manually select each geographic area to comprise the geographic region for which parking availability is requested.

In step 304, the computing device 106 may electronically transmit a request for parking space availability to the processing server 102 using a suitable communication network and method. In step 306, the receiving device 202 of the processing server 102 may receive the request, which may include at least the geographic region and may also include the geographic areas included therein, if necessary. In some embodiments, the request may also include weights for the variables used in calculating the composite score, and may also specifically indicate that a heat map is requested. In some instances, the request may also include a future period of time for which parking space availability is requested.

In step 308, the querying module 214 of the processing server 102 may execute a query on the parking database 206 to identify parking data entries 208 for each of the geographic areas comprising the geographic region. In some instances, the querying module 214 may first identify the geographic areas that comprise the geographic region, if not included in the availability request, such as by querying a lookup table that includes the geographic areas included in a given geographic region. In step 310, the calculation module 216 of the processing server 102 may calculate the composite score for each of the geographic areas. Calculation of the composite score may include calculating a normalized number of parking spots and normalized number of payment transactions for each of the geographic areas, as well as the normalization of parking costs in each geographic area, if applicable, and then calculating the composite score based thereon. The number of payment transactions for each geographic area may be normalized based on historical payment transactions during periods of time corresponding to the period of time for which availability is requested. If the availability is requested at a present period of time, then the number of payment transactions processed during the present period of time may also be used. If the availability is requested for a future period of time, then the calculation module 216 may estimate the number of transactions based on the historical transaction data.

In step 312, the analytical module 218 of the processing server 102 may generate a heat map for the geographic region. The heat map may illustrate the geographic region and include each of the geographic areas for which a composite score was calculated by the calculation module 216. The heat map may illustrate the likelihood of availability of parking for each geographic area based on the associated composite score. In an example, the heat map may use a color scale, such as going from a dark green to light green, where the brighter the shade of green, the higher the likelihood that parking is available, based on the composite score. In some cases, the heat map may include a legend to indicate the scale used.

In step 314, the transmitting device 222 of the processing server 102 may electronically transmit the heat map to the computing device 106 using a suitable communication network and method. In step 316, the computing device 106 may receive the heat map. In step 318, the computing device 106 may display the heat map to the individual 104 as a user of the computing device 106, where the individual 104 may select a parking area to go to based on the predicted availability as illustrated in the heat map.

### Calculation of Parking Availability Composite Scores

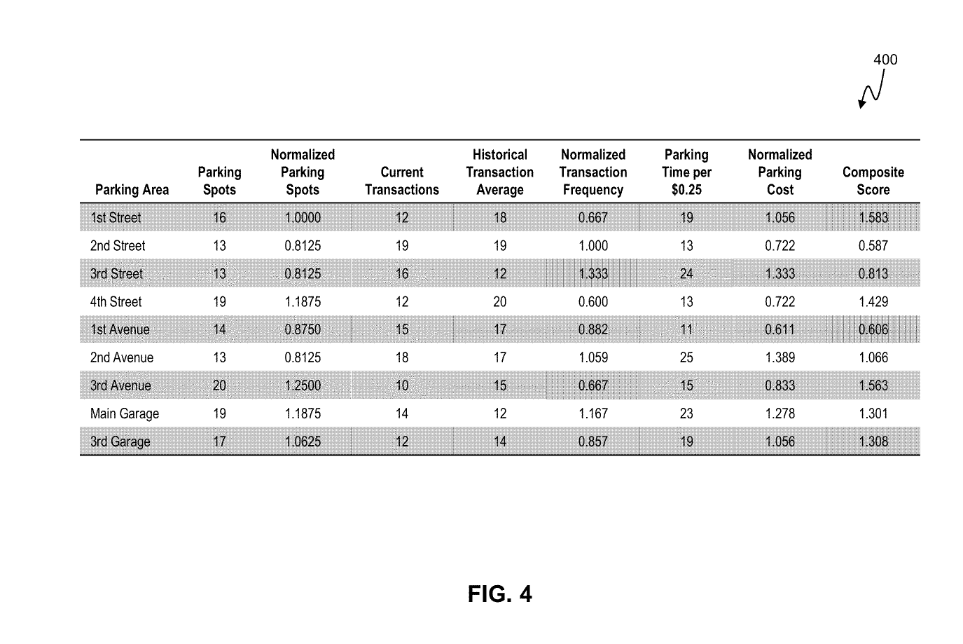

FIG. 4 illustrates a table 400 of an example calculation of composite scores for a plurality of parking areas by the processing server 102 as discussed herein.

In the example illustrated in FIG. 4, the processing server 102 may calculate the composite score for nine different parking areas, which may comprise a geographic region for which parking availability is requested. Each of the parking areas may have (e.g., stored in the associated parking data entry 208) a number of parking spots associated therewith. For instance, in the example, 1st Street has 16 available parking spots. The calculation module 216 of the processing server 102 may calculate a normalized number of parking spots for each parking area, based on the parking area's associated number of parking spots and an average number of parking spots for each of the nine parking areas. In the illustrated example, the average number of parking spots is 16, and so the normalized parking spots are calculated by dividing the parking area's associated number of parking spots by 16.

Each parking area may also have transaction data associated therewith. In the illustrated example, the processing server 102 has received (e.g., by the receiving device 202 from the payment network 108) an indication of the number of payment transactions processed in each geographic area during the current period of time, listed under the “Current Transactions” heading. The processing server 102 also has a historical average number of transactions for each parking area for the corresponding period of time, such as may be calculated by the calculation module 216 based on transaction data entries 212 stored in the transaction database 210. The calculation module 216 may calculate a normalized transaction frequency for each parking area, which, in the illustrated example, may be identified by dividing the number of current transactions by the historical transaction average for each parking area.

Each parking area may also have a parking cost associated therewith. In the illustrated example, the parking cost is represented by the amount of time in minutes that is purchased per every 25 cents spent on parking. The calculation module 216 of the processing server 102 may calculate a normalized parking cost for each of the parking areas, which, in the illustrated example, is calculated by dividing the parking cost for each parking area by the average parking cost for all of the parking areas in the geographic region. In the example, the average parking cost is 18 minutes per 25 cents spent.

The calculation module 216 of the processing server 102 may then calculate a composite score for each of the parking areas, where the composite score indicates the likelihood of parking availability in each parking area combined with the value of parking in the respective area. In the illustrated example, the composite score is calculated by first dividing the normalized parking cost by the normalized transaction frequency, and then multiplying the result by the normalized number of parking spots for the respective parking area. In the illustrated example, the 1st Street parking area has the highest composite score, due to the current number of transactions being significantly lower than normal, having an average level of parking spots, and having an above-average amount of time purchased for 25 cents. The 3rd Avenue parking area, although having a lower than average parking time for the cost, has a similarly high composite score due to the large number of parking spots and the low number of current transactions. The 2nd Street parking area has the lowest composite score, having a low number of parking spots, inefficient parking cost, and high number of payment transactions.

### Parking Availability Heat Map

FIG. 5 illustrates a heat map 500 that may be generated by the analytical module 218 of the processing server 102 to illustrate the likelihood of parking availability for geographic areas in a geographic region based on composite scores associated therewith calculated by the processing server 102.

The heat map 500 illustrates 19 different parking areas in the geographic region, where each parking area has its likelihood of parking availability illustrated using a color scale. In the example heat map 500, the color scale uses intensity to illustrate the likelihood of parking availability based on the parking area's associated composite score, where a brighter color indicates a higher composite score, and thus a higher likelihood of available parking, and a darker color indicates a lower composite score, and thus a lower likelihood of available parking. In the heat map 500, the parking area on West 15th Street, and the parking area on 5th Avenue between 14th Street and 16th Street are both shaded the brightest out of each of the parking areas, and thus are indicated to have the highest likelihood of available parking. Conversely, several parking areas, including those on West 17th Street and West 18th Street, have the darkest shades, and are thus indicated to have the lowest likelihood of available parking. The heat map 500 may be used by the individual 104 to select a parking area to drive to for an attempt to park based on the associated availability.

### Exemplary Method for Predicting Parking Space Availability Using Normalized Data

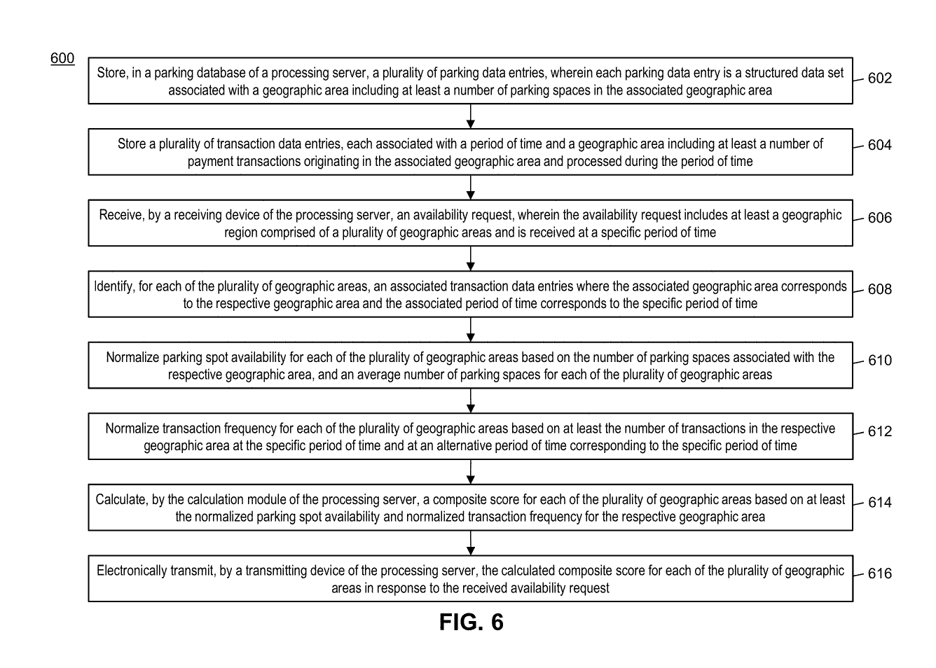

FIG. 6 illustrates a method 600 for the prediction of parking space availability for a plurality of geographic areas comprising a geographic region using normalized parking spot and transaction frequency data associated therewith.

In step 602, a plurality of parking data entries (e.g., parking data entries 208) may be stored in a parking database (e.g., the parking database 206) of a processing server (e.g., the processing server 102), wherein each parking data entry is a structured data set associated with a geographic area including at least a number of parking spaces in the associated geographic area. In step 604, a plurality of transaction data entries (e.g., transaction data entries 212) may be stored in a transaction database (e.g., the transaction database 210) of the processing server, wherein each transaction data entry is a structured data set associated with a period of time and a geographic area including at least a number of payment transactions originating in the associated geographic area and processed during the period of time.

In step 606, an availability request may be received by a receiving device (e.g., the receiving device 202) of the processing server, wherein the availability request includes at least a geographic region comprised of a plurality of geographic areas and is received at a specific period of time. In step 608, a query may be executed on the transaction database by a querying module (e.g., the querying module 214) of the processing server to identify, for each of the plurality of geographic areas, an associated transaction data entries where the associated geographic area corresponds to the respective geographic area and the associated period of time corresponds to the specific period of time.

In step 610, parking spot availability may be normalized by a calculation module (e.g., the calculation module 216) of the processing server for each of the plurality of geographic areas based on at least the number of parking spaces included in a parking data entry associated with the respective geographic area, and an average number of parking spaces included in the parking data entries associated with each of the plurality of geographic areas. In step 612, transaction frequency for each of the plurality of geographic areas may be normalized by the calculation module of the processing server based on at least the number of transactions included in a transaction data entry where the associated geographic area corresponds to the respective geographic area and the associated period of time corresponds to the specific period of time, and the number of transactions included in a transaction data entry where the associated geographic area corresponds to the respective geographic area and the associated period of time corresponds to an alternative period of time corresponding to the specific period of time.

In step 614, a composite score may be calculated by the calculation module of the processing server for each of the plurality of geographic areas based on at least the normalized parking spot availability and normalized transaction frequency for the respective geographic area. In step 616, the calculated composite score for each of the plurality of geographic areas may be electronically transmitted by a transmitting device (e.g., the transmitting device 222) of the processing server in response to the received availability request.

In one embodiment, the number of payment transactions included in each transaction data entry may be an average number of payment transactions originating in the associated geographic area and processed during the period of time for a plurality of periods. In some embodiments, the parking cost may be represented as an amount of parking time obtained for a predetermined cost amount. In one embodiment, the specific period of time may be a time range of a present day, and the alternative period of time may be the time range for a past day corresponding to a day of the week of the present day.

In some embodiments, each parking data entry may further include a parking cost for the associated geographic area and the method 600 may further include normalizing, by the calculation module of the processing server, parking cost for each of the plurality of geographic areas based on at least the parking cost included in a parking data entry associated with the respective geographic area, and an average parking cost included in the parking data entries associated with each of the plurality of geographic areas, where the composite score for each of the plurality of geographic areas is further based on the normalized parking cost for the respective geographic area. In a further embodiment, the composite score may be calculated by dividing the normalized parking cost by the normalized transaction frequency and then multiplying by the normalized parking spot availability.

In one embodiment, electronically transmitting the calculated composite score for each of the plurality of geographic areas may comprise electronically transmitting a heat map of the geographic region, where the calculated composite score is used to determine intensity of the plurality of geographic areas illustrated in the heat map. In some embodiments, the transaction database may be updated in real time using payment transactions processed by a payment network (e.g., the payment network 108). In one embodiment, the method 600 may also include: predicting, by an analytical module (e.g., the analytical module 218) of the processing server, a preferred geographic area based on at least the calculated composite score for each of the plurality of geographic areas, wherein electronically transmitting the calculated composite score for each of the plurality of geographic areas further includes electronically transmitting an indication of the preferred geographic area. In some embodiments, the number of payment transactions included in each transaction data entry may correspond to payment transactions for purchasing parking in the associated geographic area.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3 and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for predicting parking space availability using normalized data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for predicting parking space availability using normalized data, comprising:
storing, in a parking database of a processing server, a plurality of parking data entries, wherein each parking data entry is a structured data set associated with a geographic area including at least a number of parking spaces in the associated geographic area;
storing, in a transaction database of the processing server, a plurality of transaction data entries, wherein each transaction data entry is a structured data set associated with a period of time and a geographic area including at least a number of payment transactions originating in the associated geographic area and processed during the period of time;
receiving, by a receiving device of the processing server, an availability request, wherein the availability request includes at least a geographic region comprised of a plurality of geographic areas and is received at a specific period of time;
executing, by a querying module of the processing server, a query on the transaction database to identify, for each of the plurality of geographic areas, an associated transaction data entries where the associated geographic area corresponds to the respective geographic area and the associated period of time corresponds to the specific period of time;
normalizing, by a calculation module of the processing server, parking spot availability for each of the plurality of geographic areas based on at least the number of parking spaces included in a parking data entry associated with the respective geographic area, and an average number of parking spaces included in the parking data entries associated with each of the plurality of geographic areas;
normalizing, by the calculation module of the processing server, transaction frequency for each of the plurality of geographic areas based on at least the number of transactions included in a transaction data entry where the associated geographic area corresponds to the respective geographic area and the associated period of time corresponds to the specific period of time, and the number of transactions included in a transaction data entry where the associated geographic area corresponds to the respective geographic area and the associated period of time corresponds to an alternative period of time corresponding to the specific period of time;
calculating, by the calculation module of the processing server, a composite score for each of the plurality of geographic areas based on at least the normalized parking spot availability and normalized transaction frequency for the respective geographic area; and
electronically transmitting, by a transmitting device of the processing server, the calculated composite score for each of the plurality of geographic areas in response to the received availability request.

2. The method of claim 1, wherein the number of payment transactions included in each transaction data entry is an average number of payment transactions originating in the associated geographic area and processed during the period of time for a plurality of periods.

3. The method of claim 1, wherein
each parking data entry further includes a parking cost for the associated geographic area,
the method further comprises normalizing, by the calculation module of the processing server, parking cost for each of the plurality of geographic areas based on at least the parking cost included in a parking data entry associated with the respective geographic area, and an average parking cost included in the parking data entries associated with each of the plurality of geographic areas, and
the composite score for each of the plurality of geographic areas is further based on the normalized parking cost for the respective geographic area.

4. The method of claim 3, wherein the composite score is calculated by dividing the normalized parking cost by the normalized transaction frequency and then multiplying by the normalized parking spot availability.

5. The method of claim 1, wherein the parking cost is represented as an amount of parking time obtained for a predetermined cost amount.

6. The method of claim 1, wherein
the specific period of time is a time range of a present day, and
the alternative period of time is the time range for a past day corresponding to a day of the week of the present day.

7. The method of claim 1, wherein electronically transmitting the calculated composite score for each of the plurality of geographic areas comprises electronically transmitting a heat map of the geographic region, where the calculated composite score is used to determine intensity of the plurality of geographic areas illustrated in the heat map.

8. The method of claim 1, wherein the transaction database is updated in real time using payment transactions processed by a payment network.

9. The method of claim 1, wherein the number of payment transactions included in each transaction data entry correspond to payment transactions for purchasing parking in the associated geographic area.

10. The method of claim 1, further comprising:
predicting, by an analytical module of the processing server, a preferred geographic area based on at least the calculated composite score for each of the plurality of geographic areas, wherein
electronically transmitting the calculated composite score for each of the plurality of geographic areas further includes electronically transmitting an indication of the preferred geographic area.

11. A system for predicting parking space availability using normalized data, comprising:
a parking database of a processing server configured to store a plurality of parking data entries, wherein each parking data entry is a structured data set associated with a geographic area including at least a number of parking spaces in the associated geographic area;
a transaction database of the processing server configured to store a plurality of transaction data entries, wherein each transaction data entry is a structured data set associated with a period of time and a geographic area including at least a number of payment transactions originating in the associated geographic area and processed during the period of time;
a receiving device of the processing server configured to receive an availability request, wherein the availability request includes at least a geographic region comprised of a plurality of geographic areas and is received at a specific period of time;
a querying module of the processing server configured to execute a query on the transaction database to identify, for each of the plurality of geographic areas, an associated transaction data entries where the associated geographic area corresponds to the respective geographic area and the associated period of time corresponds to the specific period of time;
a calculation module of the processing server configured to
normalized parking spot availability for each of the plurality of geographic areas based on at least the number of parking spaces included in a parking data entry associated with the respective geographic area, and an average number of parking spaces included in the parking data entries associated with each of the plurality of geographic areas,
normalize transaction frequency for each of the plurality of geographic areas based on at least the number of transactions included in a transaction data entry where the associated geographic area corresponds to the respective geographic area and the associated period of time corresponds to the specific period of time, and the number of transactions included in a transaction data entry where the associated geographic area corresponds to the respective geographic area and the associated period of time corresponds to an alternative period of time corresponding to the specific period of time, and
calculate a composite score for each of the plurality of geographic areas based on at least the normalized parking spot availability and normalized transaction frequency for the respective geographic area; and
a transmitting device of the processing server configured to electronically transmit the calculated composite score for each of the plurality of geographic areas in response to the received availability request.

12. The system of claim 11, wherein the number of payment transactions included in each transaction data entry is an average number of payment transactions originating in the associated geographic area and processed during the period of time for a plurality of periods.

13. The system of claim 11, wherein
each parking data entry further includes a parking cost for the associated geographic area,
the calculation module of the processing server is further configured to normalize parking cost for each of the plurality of geographic areas based on at least the parking cost included in a parking data entry associated with the respective geographic area, and an average parking cost included in the parking data entries associated with each of the plurality of geographic areas, and
the composite score for each of the plurality of geographic areas is further based on the normalized parking cost for the respective geographic area.

14. The system of claim 13, wherein the composite score is calculated by dividing the normalized parking cost by the normalized transaction frequency and then multiplying by the normalized parking spot availability.

15. The system of claim 11, wherein the parking cost is represented as an amount of parking time obtained for a predetermined cost amount.

16. The system of claim 11, wherein
the specific period of time is a time range of a present day, and
the alternative period of time is the time range for a past day corresponding to a day of the week of the present day.

17. The system of claim 11, wherein electronically transmitting the calculated composite score for each of the plurality of geographic areas comprises electronically transmitting a heat map of the geographic region, where the calculated composite score is used to determine intensity of the plurality of geographic areas illustrated in the heat map.

18. The system of claim 11, wherein the transaction database is updated in real time using payment transactions processed by a payment network.

19. The system of claim 11, wherein the number of payment transactions included in each transaction data entry correspond to payment transactions for purchasing parking in the associated geographic area.

20. The system of claim 11, further comprising:
an analytical module of the processing server configured to predict a preferred geographic area based on at least the calculated composite score for each of the plurality of geographic areas, wherein
electronically transmitting the calculated composite score for each of the plurality of geographic areas further includes electronically transmitting an indication of the preferred geographic area.
